(19) United States
(12) Patent Application Publication
(10) Pub. No.: US 2010/0088186 A1
(43) Pub. Date: Apr. 8, 2010

(54) ADVERTISING INVENTORY CONTROLS

(76) Inventors: Scott Shifflett, Burbank, CA (US); Steven Hartman, Burbank, CA (US); Matt Plummer, Porter Ranch, CA (US); Sundar Seshadri, Santa Clara, CA (US); Robert van Gent, Santa Clara, CA (US); Kara Perry, Stevenson Ranch, CA (US); Brad Ciraulo, Santa Clara, CA (US); Venkatesh B. Natrajan, Santa Clara, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 12/247,968

(22) Filed: Oct. 8, 2008

(51) Int. Cl. G06Q 30/00

(52) U.S. Cl. 705/14.73

(57) ABSTRACT

Embodiments of methods, apparatuses, or systems associated with advertising inventory controls are disclosed.

### BACKGROUND

1. Field

The subject matter disclosed herein relates to advertising inventory controls.

2. Information

Advertising is everywhere. Advertisements may be found in nearly every medium of expression throughout much of human history. Surely, there is a hieroglyphic in a cave somewhere advertising Mammoth taxidermy services. Still true today, advertisements may be found in our most modern medium of expression: the online world. Increased use and availability by consumers of the online world presents opportunities for advertisers to reach audiences unprecedented on a historical scale. Likewise, the online world also presents opportunity for those that own or operate online advertising space to generate advertising revenue.

While a marriage between those that wish to advertise and those that own space would appear harmonious, the reality is quite the opposite. One reason, for example, is that the marketplace to join potential purchasers with potential sellers of relevant online advertising space is inefficient and costly. Thus, other methods or technologies may be desired.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a flowchart depicting an embodiment of a method to communicate electronically regarding online advertising inventory;

FIG. 2 is a schematic diagram depicting an embodiment of a set of restrictions;

FIG. 3 is a diagram depicting an embodiment of a system to communicate electronically regarding online advertising inventory via an exchange.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” or “an embodiment” in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and,” “and/or,” and “or” as used herein may include a variety of meanings that will depend at least in part upon the context in which it is used. Typically, “or” as well as “and/or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms and/or symbolic representations of operations on data bits or binary digital signals stored within a computing system memory, such as a computer memory. These algorithmic descriptions or representations are the techniques used by those of ordinary skill in the data processing arts to convey the substance of their work to others skilled in the art. An algorithm is here, and generally, considered to be a self-consistent sequence of operations and/or similar processing leading to a desired result. The operations or processing involve physical manipulations of physical quantities. Typically, although not necessarily, these quantities may take the form of electrical or magnetic signals capable of being stored, transferred, combined, compared or otherwise manipulated. It has proven convenient, at times, principally for reasons of common usage, to refer to these signals as bits, data, values, elements, symbols, characters, terms, numbers, numerals or the like. It should be understood, however, that all of these and similar terms are to be associated with the appropriate physical quantities and are merely convenient labels. Unless specifically stated otherwise terms such as “processing”, “computing”, “calculating”, “determining” or the like refer to the actions or processes of a computing platform, such as a computer or a similar electronic computing device, that may be capable of performing mathematical or logical operations on data, which may also include being capable of storing the results of performing such operations. Thus, data, of course, may include, for example, any information which may be capable of being perceived, employed, stored, or transmitted by a computing platform, such as program code, executable instructions, or text, as non-limiting examples.

As mentioned previously, the marketplace to join potential purchasers with potential sellers of relevant online advertising space is inefficient and costly. Currently, purchasers of online advertising space typically first identify and then negotiate with particular owners or operators of the online space they are interested in purchasing. In addition, added inefficiently may exist due to the fact that numerous entities own or operate online advertising space. Thus, a purchaser may sometimes duplicate its efforts with new sellers to obtain advertising in a space owned or controlled by the new seller.

Likewise, inventory owners or operators may also find the marketplace inefficient and costly. For example, many owners may want to control the way their inventory may be used or sold. To illustrate, owners of a particular website for home appliances, for example, may want a certain type or range of advertisements that relate to the home appliance industry. They may desire to have advertisements for a service provider, such as a custom installer, for example, or for no one advertiser to purchase more than 10% of the advertising on their page. Presently, however, potential sellers of online advertising inventory may have to disclose and negotiate these or other preferences with each, new potential purchaser on an individual basis.

Moreover, the general trend of the advertising industry, at least at it may relate to advertising in the online world, has been to become increasingly balkanized and isolationist. This trend has tended to coincide with the increasingly diverse ownership of online advertising space by disparate entities. Furthermore, increasing capacity on the web may only further exasperate concerns with the current approach. Accordingly, as mentioned previously, other methods or technologies are desired.

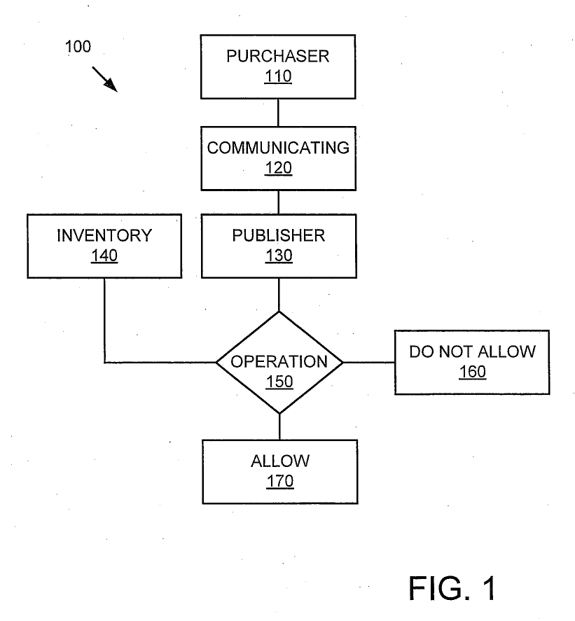

In FIG. 1, embodiment 100 is a flowchart depicting an embodiment of a method to communicate electronically regarding online advertising inventory. In this particular embodiment, potential purchaser 110 is shown communicating 120 with the internal sales organization of publisher 130. For example, a computing platform of purchaser 110 may communicate with one or more computing platforms of publisher 130 regarding online advertising inventory. In this context, the term communicate means a transmission or receipt of data. Accordingly, in some embodiments, communicating may represent an exchange of data occurring between the computing platforms of potential purchasers or potential sellers. In some embodiments, however, communicating may occur in only one direction; for example, a potential purchaser may solicit data regarding online advertising inventory where no exchange of data with the purchaser's computing platform may take place.

Here, potential purchaser 110 solicits information regarding online advertising inventory 140. Purchaser 110 may choose to communicate with publisher 130 because publisher 130 may own or otherwise control online advertising inventory 140, such as owning or providing content for one or more online sites or networks, for example, or because the publisher may be acting as an agent for one or more entities that own or control content on one or more sites or networks, as another example.

In this embodiment, online advertising inventory 140 represents advertising space available on a webpage operated or controlled by publisher 130; in other embodiments, however, online advertising inventory need not represent webpage space at all. For example, inventory 140 may represent advertising space available on the Internet or an intranet, which may or may not include being accessible via the World Wide Web. Likewise, online advertising inventory may also represent not just the advertising space itself, but particular characteristics or attributes of the inventory, such as its content, size, positioning, and audience demographic or behavioral characteristics or attributes, as non-limiting examples.

In this embodiment, the publisher's computing platform receives a communication from purchaser 110 and determines at operation 150 whether the communication is related to particular online advertising inventory. Operation 150 may make this determination in a variety of ways and based on a variety of information. For example, in this embodiment, operation 150 may have sufficient information from purchaser 110's communication to identify the particular online advertising inventory in which purchaser 110 may be interested. In another embodiment, however, operation 150 may route purchaser 110 to a landing page in the publisher's system, which may be designed to ferret out purchaser 110's request, such as where a user via a computing platform may input information or answer questions. Or, as another example, operation 150 may query purchaser 110's computing platform, which may contain data relating to purchaser 110's solicitation, such as where a purchaser stored information related to its request in a computing platform.

In addition, in this embodiment, operation 150 compares data from purchaser 110's communication with a database which associates inventory, or its characteristics or attributes, with one or more restrictions. This determination may be achieved with logic designed to compare or associate look up tables in a database, for example. If operation 150 determines that the communication is related to restricted online advertising inventory, the computing platform communicating with the purchaser, or a system to which the platform may be communicatively coupled, may be instructed by operation 150 to restrict communications regarding that particular online advertising inventory substantially in accordance with a set of restrictions with respect to that inventory. These restrictions are discussed in more detail below. For now, however, a simplified illustration of some of the concepts already discussed may be helpful.

Assume in embodiment 100 that purchaser 110 is a sporting goods store located in Houston, Tex. This purchaser may solicits information from a publisher 130, an internal sales organization of the Houston Chronicle, which is responsible for selling advertising on the Chronicle's sports page. The purchaser may be inquiring whether it may purchase online advertising space 140 on the Chronicle's sports page to market the store's wares to potential customers. The Chronicle's computing platform receives the purchaser's communication and determines, via operation 150, that online advertising space 140 is subject to restrictions. Reviewing the purchaser's communication in light of the restrictions, operation 150 determines that the store may purchase the available online inventory. In this illustration, operation 150 allowed the purchaser to buy the particular restricted inventory. Thus, in embodiment 100, for example, operation 150 may allow a transaction to proceed, as in did in the illustration, such as depicted by box 170; or, in other embodiments, operation 150 may not allow a transaction to proceed, such as depicted by box 160.

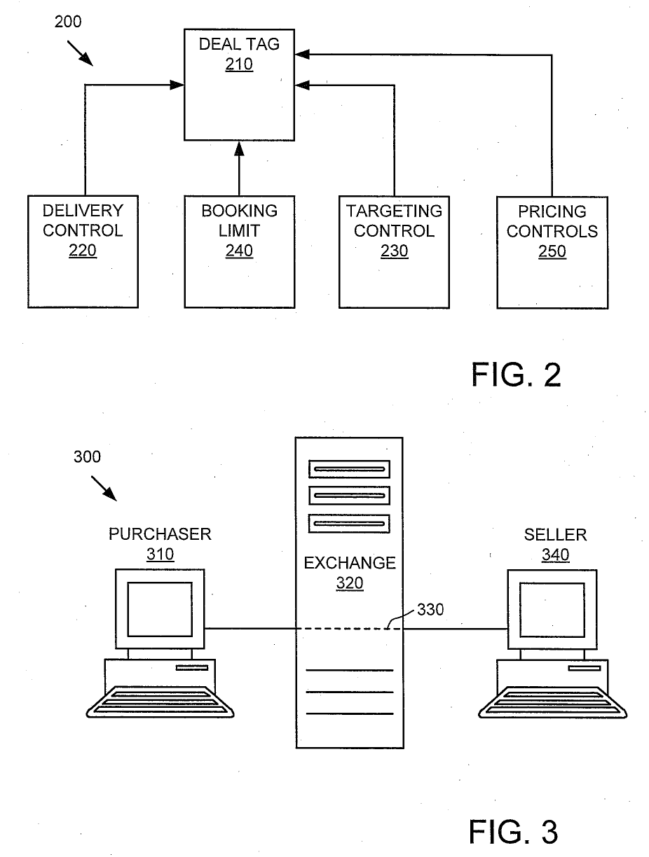

Embodiment 200, in FIG. 2, is a schematic diagram depicting a set of restrictions. In this embodiment, restrictions allow an entity to specify if and how its online advertising inventory may be purchased or used via the application or enforcement of one or more restrictions with respect to the inventory. For example, the restrictions shown in this embodiment may, alone or in combination, be applied to online advertising inventory, including its attributes or characteristics.

Here, one or more of these restrictions may comprise deal tag 210. Furthermore, deal tag 210 may contain one or more restrictions that more specifically address how an entity may control its inventory. In some embodiments, one or more restrictions may comprise a deal tag; in other embodiments, particular restrictions may be shared across one or more deal tags. For ease of description, we have grouped restrictions into the following categories: delivery controls, targeting controls, booking limits and pricing controls.

In this embodiment, delivery controls 220 are one or more restrictions that allow an entity, or its agent, to restrict which inventory may be exposed or available to potential purchasers. In other words, delivery controls allow an entity to restrict the availability of inventory for purchase based, at least in part, on the source of the demand. For example, an entity may desire that only subsidiaries or internal organizations may purchase particular advertising inventory. Accordingly, the entity may apply a delivery control to that particular inventory to restrict the inventory's exposure or availability to external potential purchasers. Thus, in this example, an external potential purchaser may not be permitted to view or purchase that particular inventory; whereas, subsidiary or internal organization may view or purchase that particular inventory.

Of course, as mentioned previously with regard to online advertising inventory, it may encompass more than merely advertising space; it may encompass characteristics or attributes which may relate to the space or its use. Accordingly, delivery controls may be applied against various characteristics or attributes of inventory, including ad size, or ad content, as non-limiting examples.

Targeting controls 230, in embodiment 200, are one or more restrictions that allow an entity, or its agent, to limit how online advertising inventory may be used. There are numerous types of restrictions that may be applied, alone or in combination, against online advertising inventory or its associated characteristics or attributes. As some non-limiting examples, restrictions may be provided to control content type, content topic, ad size or position, or target audience characteristics, such as their demographic or behavioral characteristics or attributes.

To help illuminate the capabilities of targeting controls, let's return to the Houston Chronicle example above. The operators of the Chronicle's sport page may desire to have particular inventory remaining on its sport page filled, not by a sporting goods vendor, but by a home and garden advertiser. Perhaps the Chronicle believes that it has enough advertisements for sporting goods. The Chronicle may establish a targeting control which restricts the use of that particular inventory to home and garden content. Thus, the restrictions enforced against that particular inventory would restrict potential purchasers from posting other than home and garden content. This, of course, is merely an example and the scope of claimed subject matter, accordingly, is not limited by this example.

Likewise, while the example above appeared to have a targeting control worded in the imperative—that is, allowing particular content only—targeting controls may be specified to grant the potential purchaser some discretion or leeway. Thus, for example, a targeting control may specify a series of values or categories that may be permissible, such as by giving the purchaser possibilities or choices; similarly, a targeting control may express an entity's preference to target particular market segment or market attributes, as another example.

Booking limits 240, in this embodiment, are one or more restrictions that allow an entity, or its agent, to limit the amount of inventory one or more purchasers can buy. For example, an entity may desire to have a particular purchaser not purchase more than 25% of its online advertising inventory. Accordingly, the entity may establish a booking limit which would restrict the ability of a purchaser to buy less than or equal to 25% of its inventory. Likewise, as with other restrictions, booking limits may be applied to numerous inventory attributes or characteristics, such as content topic, as an example. Thus, booking limits may be applied to prevent similar content from occupying more than 50% of a particular webpage, where the exiting content may comprise advertisements from a multiplicity of purchasers, as an example.

Also, in this embodiment, pricing controls 250 are one or more restrictions that allow an entity to apply different pricing schemes to one or more purchasers. For example, particular inventory may be available to internal or subsidiary purchasers at a different price point, or under different terms, than particular inventory which may be available to external purchasers. Of course, other ways of discriminating against particular purchasers, other than the internal versus external purchasers, may be applied.

In the interests of not obscuring the scope claimed subject matter, it is important to note that only a few examples were given of the types of restrictions that may be applied against inventory or its associated characteristics or attributes. Likewise, only a few examples were give regarding the characteristics or attributes of inventory. Of course, however, we intended to cover within the scope of claimed subject restrictions which may not be neatly, nor at all, be categorized as delivery controls, targeting controls, booking limits, pricing controls, or some combination thereof, that may be applied against inventory or any of its characteristics or attributes.

With respect to the application of restrictions against inventory, depending on the embodiment, one or more restrictions may be applied to online advertising inventory at a variety of levels, such as at the site, publisher, or network level, as non-limited examples. For example, an entity may establish a targeting control to restrict the use of particular content for inventory on a particular site, but may allow that particular content otherwise through the rest of the entity's network.

Embodiment 300, in FIG. 3, depicts a system to communicate electronically regarding online advertising inventory via an exchange. In this embodiment, a computing platform of purchaser 310 is communicatively coupled to a computing platform of exchange 320. Similarly, a computing platform of seller 340 is communicatively coupled to exchange 320, here depicted as a computing platform.

In this embodiment, exchange 320 may act as a kind of agent or intermediary for seller 340. However, in other embodiments, exchange 320 may act as a kind of agent or intermediary for one or more buyers or sellers, or any combination thereof. Here, for example, seller 340 may have created restrictions, such as the restrictions previously described in embodiment 200, to be applied or enforced against its online advertising inventory. In this embodiment, this information about seller 340's inventory or restrictions may be communicated to exchange 320 by a computing platform of seller 340.

In this embodiment, a computing platform of purchaser 310 may communicate with exchange 320 via the web, or other communication paths, regarding online advertising inventory owned or operated by seller 340. Accordingly, purchaser 310 may be capable of communicating with the online advertising inventory reservation system of exchange 320. The inventory reservation system of exchange 320 is capable of performing operations similar to operation 150 in embodiment 100, such as previously described. Thus, exchange 320 may determine that one or more communications from purchaser 310 occurs substantially in accordance with one or more restrictions with regard to seller 340's inventory. In other words, exchange 320 imposes restrictions regarding the inventory set by seller 340.

In addition, embodiment 300 depicts path 330. In this embodiment, path 330 represents an authorized link between purchaser 310 and seller 340. This path, for example, may have been authorized by seller 340 after a request by purchaser 310. In embodiment 300, path 330 may serve as link for purchaser 310 to communicate with seller 340. Alternatively and additionally, in other embodiments, path 330 may serve as link for purchaser 310 to communicate with seller 340, where a computing platform for seller 340, and not exchange 320, enforces or applies restrictions regarding the seller's inventory, such as previously described. In addition, in other embodiments, a seller may have created or authorized one or more paths to one or more similar or different purchasers.

Paths, such as path 330, may also permit a seller, or an exchange, to apply or enforce restrictions at the path level. As mentioned previously, for example, one or more restrictions may be applied to a site, publisher, or network level. Here, in embodiment 300, however, one or more restrictions may also be applied at the path level. Accordingly, one or more restrictions may be associated with one or more paths through an exchange.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
communicating electronically regarding online advertising inventory with at least one of the following: potential purchasers, potential sellers, or any combination thereof;
one or more of the electronic communications occurring substantially in accordance with one or more restrictions.

2. The method of claim 1, wherein said communicating electronically takes place via an electronic exchange.

3. The method of claim 2, wherein said electronic exchange comprises a worldwide web based electronic exchange.

4. The method of claim 1, wherein said one or more restrictions are imposed by an entity other than the entity providing one or more communications.

5. The method of claim 1, wherein said inventory is provided by an entity other than the entity providing one or more communications.

6. The method of claim 1, wherein said one or more restrictions includes at least one of the following: delivery controls, targeting controls, pricing controls, booking limits, or any combination thereof.

7. The method of claim 1, wherein said one or more restrictions are applied to said online advertising inventory at one or more levels; said one or more levels comprising at least one of the following: site level, publisher level, network level, path level, or any combination thereof.

8. The method of claim 1, wherein said one or more restrictions are applied to one or more characteristics or attributes of said online advertising inventory.

9. An apparatus comprising:
a computing platform;
said computing platform operable to communicate electronically regarding online advertising inventory with at least one of the following:
potential purchasers, potential sellers, or any combination thereof;
said computing platform being further operable so that one or more of the electronic communications occur substantially in accordance with one or more restrictions applicable to said online advertising inventory.

10. The apparatus of claim 9, wherein said computing platform is capable of being communicatively coupled to a network.

11. The apparatus of claim 9, wherein said computing platform is further operable to act as an electronic exchange.

12. The apparatus of claim 11, wherein said electronic exchange comprises an inventory reservation system.

13. The apparatus of claim 11, wherein said electronic exchange is operated by an entity other than the entity providing one or more communications.

14. The apparatus of claim 9, wherein said computing platform is further operable to enforce one or more restriction set by one or more potential sellers.

15. The apparatus of claim 14, wherein said computing platform is further operable to enforce said one or more restrictions against one or more communications paths in an exchange.

16. The apparatus of claim 9, wherein said computing platform comprises an online inventory system in which one or more restrictions are applicable to at least portions of said online inventory; at least one of said restrictions comprising reservation of online advertising inventory.

17. An article comprising: a storage medium having instructions stored thereon;
said storage medium, if said instructions are executed, further instructing a computing platform to communicate electronically regarding online advertising inventory with at least one of the following: potential purchasers, potential sellers, or any combination thereof;
one or more of the electronic communications occurring substantially in accordance with one or more restrictions.

18. The article of claim 17, wherein said instructions, if executed, further instruct a computing platform to apply said one or more restrictions to said online advertising inventory, at least in part.

19. The article of claim 18, wherein said instructions, if executed, further instruct a computing platform to apply said one or more restrictions to said online advertising inventory at one or more levels; said one or more levels comprising at least one of the following: site level, publisher level, network level, or any combination thereof.
